(19) United States
(12) Patent Application Publication
(10) Pub. No.: US 2023/0123286 A1
(43) Pub. Date: Apr. 20, 2023

(54) TRANSMISSION DEVICE FOR GUIDING TRANSMISSION SIGNAL

(71) Applicant: QuantumZ Inc., Kaohsiung City (TW)

(72) Inventors: CHUN-CHIEH CHEN, Kaosiung City (TW); PO-TING CHEN, Kaosiung City (TW); LONG-YI LIN, Kaosiung City (TW); CHAO-HUI KUO, Kaosiung City (TW)

(21) Appl. No.: 17/502,889

(22) Filed: Oct. 15, 2021

(51) Int. Cl. G02B 6/42

(52) U.S. Cl. CPC G02B 6/4214; G02B 6/4203; G02B 6/4274

(57) ABSTRACT

A transmission device for guiding a transmission signal is provided, including: a substrate including a signal guide configured to guide the transmission signal; and a refractor arranged on the substrate and corresponding to the signal guide, the refractor provided with a progressive refractive index with which a divergence angle of the transmission signal progressively varies within the refractor.

### BACKGROUND OF THE INVENTION

### Field of the Invention

The present invention relates to a transmission device for guiding a transmission signal.

### Description of the Prior Art

With the progression of the internet and telecommunication in recent years, the large data transmission has been required. Conventionally, electrical signal is used to transmit data. However, the coupling efficiency and bandwidth of the electrical transmission way are more and more insufficient. Accordingly, optical transmission device is therefore developed.

In a conventional optical transmission device, there is usually an air gap between the optical waveguide board and the optical transmitter or the optical receiver, which causes the divergence angle of the light projecting from the optical transmitter toward the optical waveguide board or the divergence angle of the light projecting from the optical waveguide board toward the optical receiver large, and this results in high loss and low optical coupling efficiency, especially in the broadband communication.

The present invention is, therefore, arisen to obviate or at least mitigate the above-mentioned disadvantages.

### SUMMARY OF THE INVENTION

An object of the present invention is to provide a transmission device for guiding a transmission signal which achieves low loss and high coupling efficiency.

To achieve the above and other objects, a transmission device for guiding a transmission signal is provided, including: a substrate including a signal guide configured to guide the transmission signal; and a refractor arranged on the substrate and corresponding to the signal guide, the refractor provided with a progressive refractive index with which a divergence angle of the transmission signal progressively varies within the refractor.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a cross-sectional view of a preferable embodiment of the present invention;

FIG. 2 is a partial enlargement of FIG. 1;

FIGS. 3 to 5 are drawings showing transmission devices including different reflective mechanisms according to preferable embodiments of the present invention;

FIG. 6 is a drawing showing a transmission device including a stiffener according to a preferable embodiment of the present invention;

FIGS. 7 to 9 are drawings showing transmission devices including different conductive components according to preferable embodiments of the present invention;

FIG. 10 is a drawing showing a transmission device including transmitting (Tx) and receiving (Rx) modules according to a preferable embodiment of the present invention; and

FIG. 11 is a drawing showing a transmission device including another reflective mechanism according to a preferable embodiment of the present invention.

### DETAILED DESCRIPTION OF THE PREFERRED EMBODIMENTS

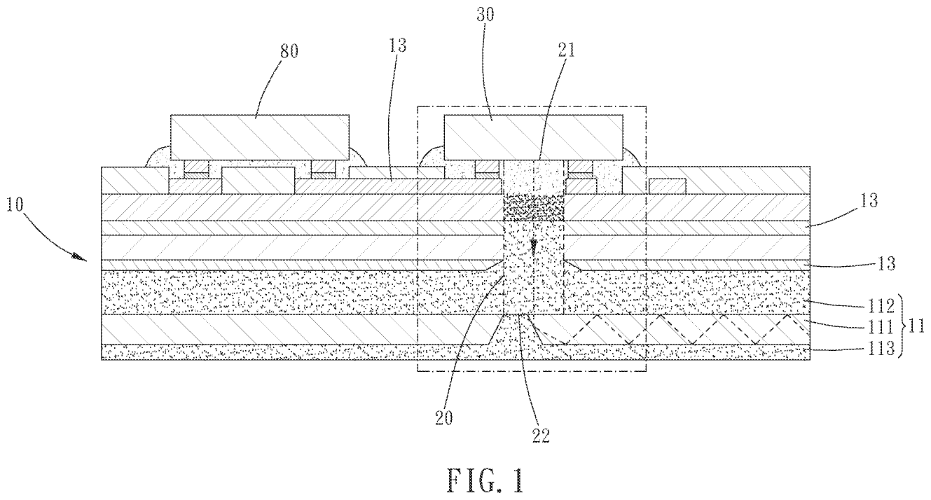

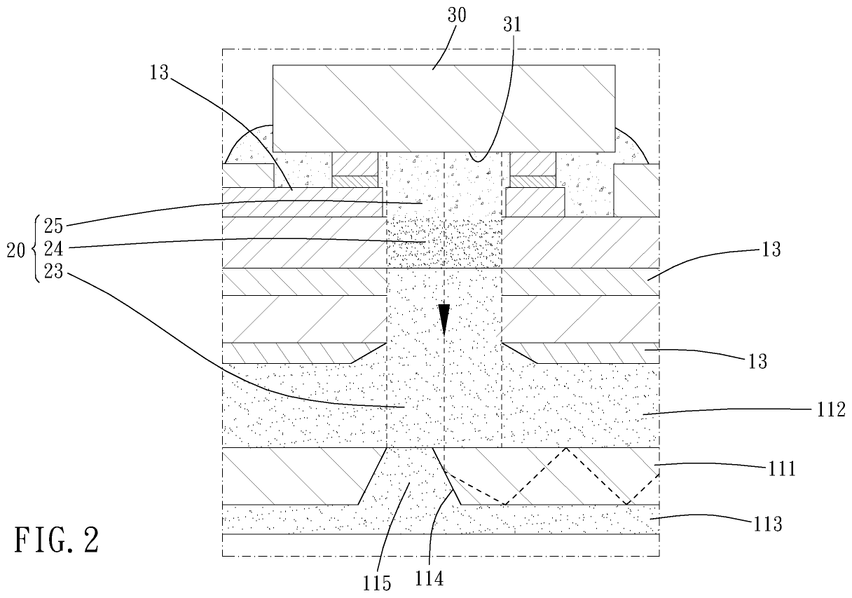

Please refer to FIGS. 1 to 2 for a preferable embodiment of the present invention. A transmission device for guiding a transmission signal of the present invention includes a substrate 10 and a refractor 20 (region between dashed lines).

The substrate 10 includes a signal guide 11 configured to guide the transmission signal. The transmission signal may refer to optical wave, or any wave signal which can be used to transmit data. The transmission signal may be coded in any coded signal before or after being transmitted by the transmission device. The refractor 20 is arranged on the substrate 10 and corresponds to the signal guide 11, wherein the refractor 20 is provided with a progressive refractive index with which a divergence angle of the transmission signal progressively varies within the refractor 20. For example, the divergence angle of the transmission signal from an optical component (for example, optical transmitter such as vertical cavity surface emitting laser (VCSEL) or LED) toward the refractor 20 or the divergence angle of the transmission signal from the refractor 20 toward an optical component (for example, optical receiver such as photodiode (PD)) can be effectively narrowed, which converges and densifies the transmission signal and effectively improves optical coupling efficiency.

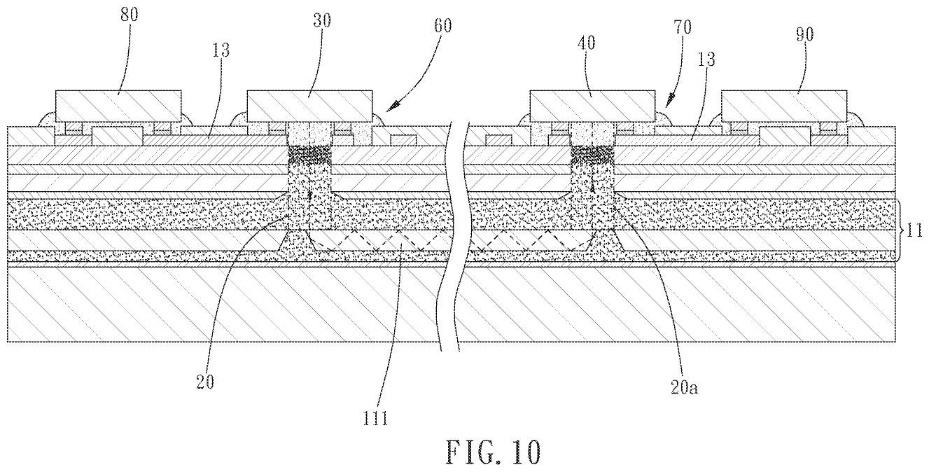

The refractor 20 includes a first end 21 and a second end 22, the second end 22 is connected to the signal guide 11, and the progressive refractive index progressively increases or progressively decreases along an arrangement direction from the first end 21 to the second end 22. As the refractor 20 is disposed to correspond to an optical transmitter 30, the progressive refractive index progressively increases along the arrangement direction; as the refractor 20 is disposed to correspond to an optical receiver 40 (FIG. 10), the progressive refractive index progressively decreases along the arrangement direction.

The refractor 20 includes a plurality of layers of different refractive indices, and the refractive indices of every neighboring two of the plurality of layers preferably have a suitable difference, for effectively and reliably refracting the transmission signal. The plurality of layers may be integrally formed or formed layer by layer. The signal guide 11 includes a transmission layer 111 and a first layer 112 on the transmission layer 111, and a part 23 of the first layer 112 is formed as a part of the refractor 20. The refractor 20 further includes an interposed layer 24 and an upper layer 25, the interposed layer 24 is disposed between the part 23 of the first layer 112 and the upper layer 25, and the upper layer 25 is configured to be disposed adjacent the optical component. The interposed layer 24 and the upper layer 25 may be high transmittance glue, optical glue, underfill material, or any organic or inorganic transmittance material with a refractive index smaller than a refractive index of the transmission layer 111. In an exemplary embodiment, a refractor may be provided with a progressive refractive index progressively increasing and includes an upper layer with a refractive index of 1.49, an interposed layer with a refractive index of 1.53 and an part of the first layer with a refractive index of 1.554, and the transmission layer is provided with a refractive index of 1.57; a refractor may be provided with a progressive refractive index progressively decreasing and includes an upper layer with a refractive index of 1.64, an interposed layer with a refractive index of 1.60 and an part of the first layer with a refractive index of 1.554, and the transmission layer is provided with a refractive index of 1.57. It is noted that the refractor 20 may include two or more than three layers of different refractive indices and that their refractive indices may not be limited to those values mentioned above.

The signal guide 11 further includes a second layer 113 on the transmission layer 111 and opposite to the first layer 112. Each of the first layer 112 and the second layer 113 is provided with a refractive index smaller than a refractive index of the transmission layer 111 so that the transmission signal can be transmitted by total reflection in the signal guide 11.

Each of the signal guide 11 and the refractor 20 contains at least one organic or inorganic transmittance material with a refractive index preferably from 1.3 to 1.6. The organic or inorganic transmittance material may be epoxy, polyimide or acrylic, or any transmittance material with a refractive index smaller than a refractive index of the transmission layer 111. The organic or inorganic transmittance material may be provided with light transmittance not less than 80%.

The signal guide 11 may further include a reflective face 114 corresponding and angled to an end face of the refractor 20 facing toward the signal guide 11. The reflective face 114 is configured to reflect the transmission signal from the refractor 20 toward the transmission layer 111 or configured to reflect the transmission signal from the transmission layer 111 toward the refractor 20.

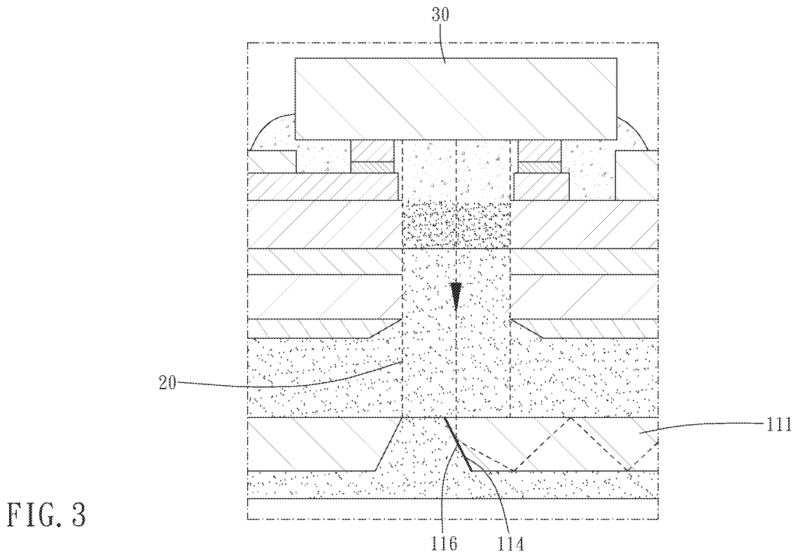

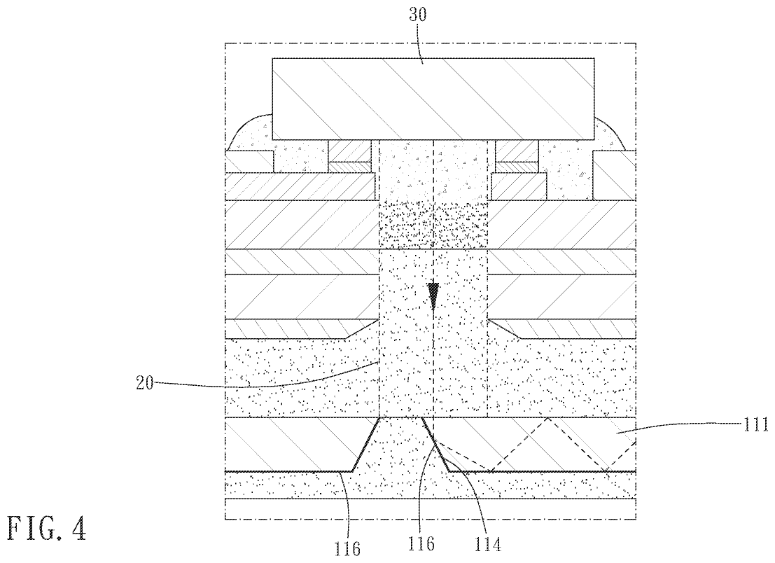

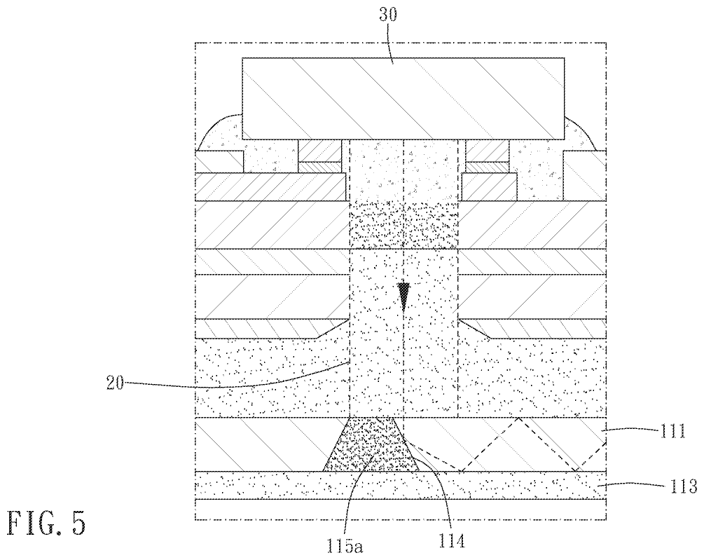

The signal guide 11 further includes a substance 115 next to the transmission layer 111, and the substance 115 may be inorganic or organic. A refractive index of the substance 115 is smaller than a refractive index of the transmission layer 111, and the reflective face 114 is formed between the transmission layer 111 and the substance 115. In this embodiment, part of the second layer 113 serves as the substance 115 next to the transmission layer 111 to form the reflective face 114. In other embodiments, the signal guide 11 may further include a metallic layer 116 or a layer of high reflectivity on which the reflective face 114 is located, and the metallic layer 116 or the layer of high reflectivity may be disposed on an inner face of a cavity of the transmission layer 111 (FIG. 3), or may cover the entire bottom side of the transmission layer 111 (FIG. 4); or, the substance 115a may be provided with another material different from the second layer 113 (FIG. 5), wherein the substance 115a may be in gaseous, liquid or solid state, such as air, water or metal, or any substance with a refractive index smaller than a refractive index of the signal guide 11, and the transmission signal can be transmitted in total reflection in the signal guide 11.

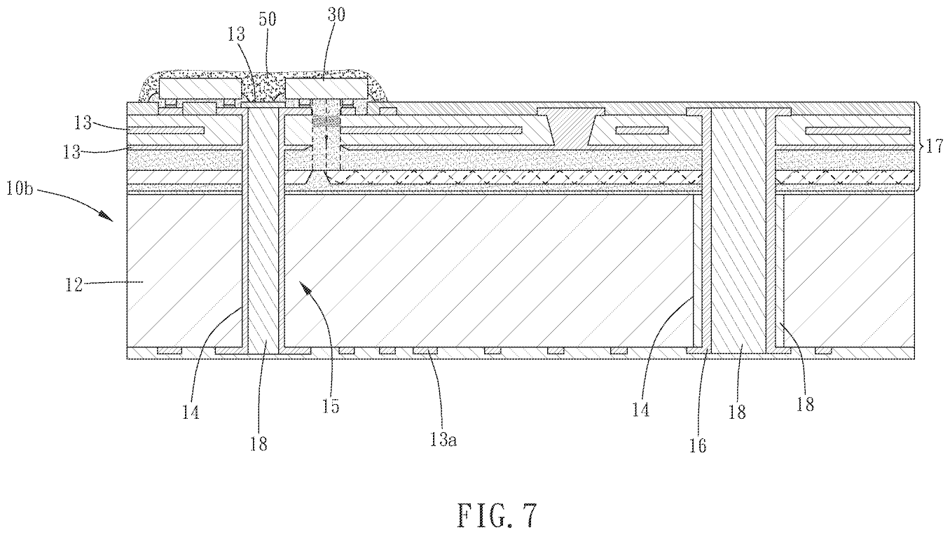

The transmission device may further include an optical component (optical transmitter 30 or optical receiver 40), wherein the optical component is arranged on the substrate 10 and corresponds to the refractor 20. Preferably, a covering component 50 is provided to cover the optical component (FIG. 7), wherein the covering component 50 may be molding compound and is provided with electromagnetic wave shielding and a thermal conductivity greater than 3 W/mK, which can lower the electromagnetic wave interference and improves thermal effect.

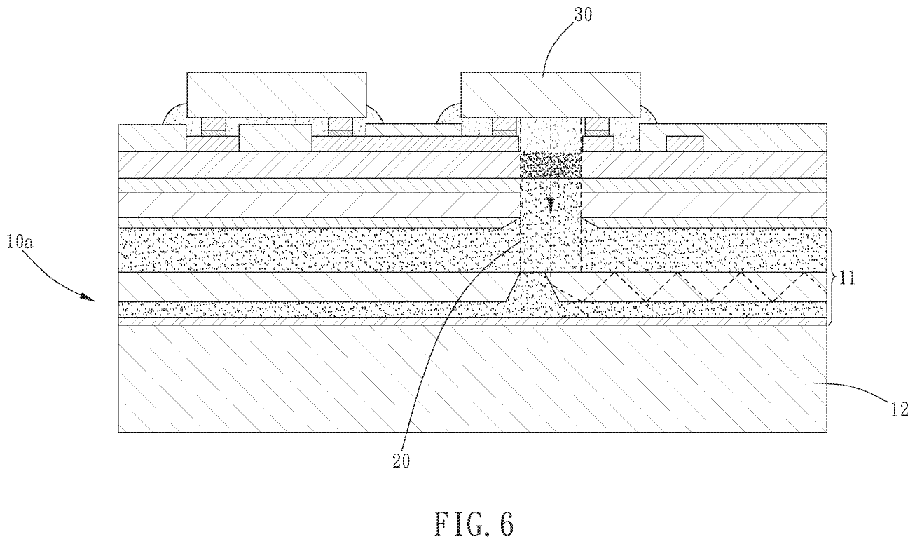

Preferably, as shown in FIG. 6, the substrate 10a further includes a stiffener 12 on which the signal guide 11 is disposed, which can strengthen the substrate 10a. The stiffener 12 may be a sheet of metal (such as steel) or polymer (such as polyimide).

Please refer to FIG. 7, the substrate 10b may further include at least one electric conductive layer 13, at least one through hole 14 which is disposed at least through the at least one electric conductive layer 13, and at least one conductive component arranged along the at least one through hole 14, and the at least one conductive component may be connected with the at least one electric conductive layer 13. The at least one conductive component includes at least one of a thermal conductive component 15 and an electric conduct via 16. The at least one electric conductive layer 13 is preferably included in a circuit board 17. The at least one conductive component includes at least one of inorganic and organic solid substances, wherein the at least one of inorganic and organic solid substances may contain metallic, polymer or epoxy. Preferably, there may be at least one conductive layer 13a and/or FPC disposed on the bottom side of the stiffener 12 for expansive electric functions and/or applications.

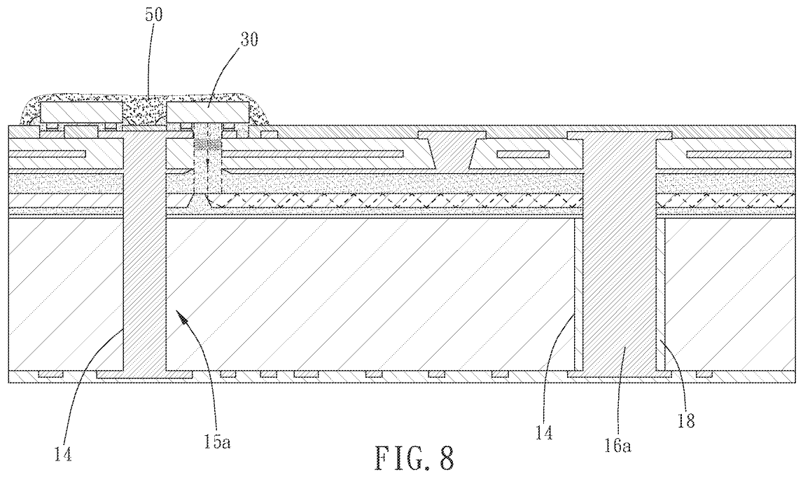

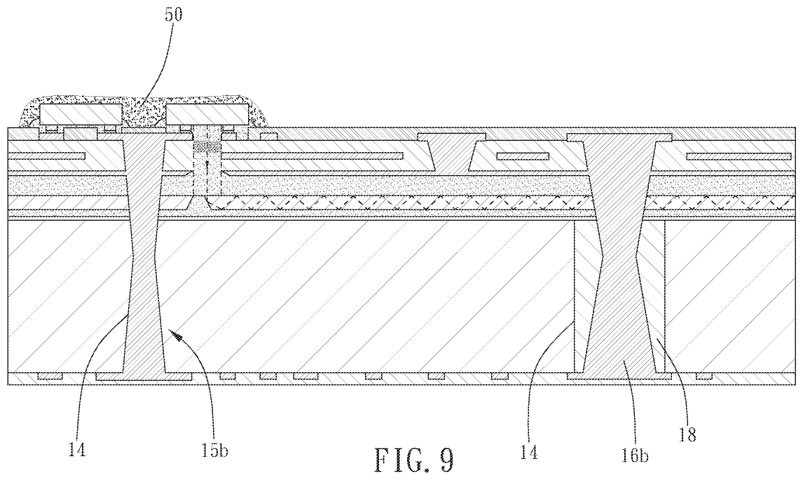

In an exemplary embodiment as shown in FIG. 7, each of the thermal conductive component 15 and the electric conduct via 16 is metallic and hollow and extends through the through hole 14, and is filled up with the at least one of inorganic and organic solid substances 18, for providing good heat dissipation and expansive electric arrangement, respectively. In other exemplary embodiments as shown in FIGS. 8 and 9, each of the thermal conductive component 15a, 15b and the electric conduct via 16a, 16b is metallic and solid and extends through the through hole 14, and the at least one of inorganic and organic solid substances 18 is disposed around the electric conduct via 16a, 16b. It is noted that the at least one conductive component may be provided in any suitable shape or configuration according to various requirements and/or applications.

In an exemplary embodiment as shown in FIG. 10, the transmission device further includes a transmitting (Tx) end 60, a receiving (Rx) end 70, a driver IC 80 and a transimpedance amplifier (TIA) 90, wherein the substrate 10 further includes an optical transmitter 30 electrically connected with the driver IC 80 via the at least one electric conductive layer 13 is arranged at the transmitting end 60 and corresponds to the refractor 20, an optical receiver 40 electrically connected with the transimpedance amplifier 90 via the at least one electric conductive layer 13 is arranged at the receiving end 70 and corresponds to another said refractor 20a, and the optical transmitter 30, the optical receiver 40, the driver IC 80 and the transimpedance amplifier 90 are connected with the at least one electric conductive layer 13.

The driver IC 80 drives the optical transmitter 30 to emit light with transmission signal, the light is projected toward the transmission layer 111 of the signal guide 11 with the divergence angle of the light which is narrowed by the refractor 20, and the light is guided in the signal guide 11 and transmitted to an optical receiver 40; the light is projected toward the optical receiver 40 with the divergence angle of the light which is narrowed by the refractor 20a, and the transmission signal received by the optical receiver 40 is then processed by the transimpedance amplifier 90, for post-process or post-application. It is noted that additional electric and/or optical component(s) may be introduced into any transmission device mentioned above.

In practice, the divergence angle of the light of a conventional optical transmission device with an air gap between the signal guide and the optical transmitter or the optical receiver can be 32 degrees or more; however, at the Tx end 60, the divergence angle of the light of the transmission device of the present invention with the refractor 20 provided with the progressive refractive index can be narrowed to 12 degrees or less, and at the Rx end 70, the divergence angle of the light can be narrowed, by the refractor 20a, to 28 degrees or less. This can efficiently improve transmission efficiency and optical coupling efficiency.

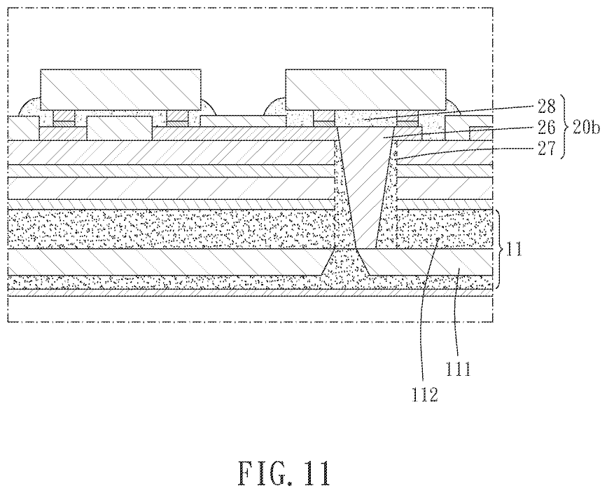

In an exemplary embodiment as shown in FIG. 11, the refractor 20b includes a core 26 corresponding to the signal guide 11, a cladding 27 disposed around the core and an optical layer 28 disposed on the core. The core 26 and the optical layer 28 are provided with different refractive indices, and the transmission signal can be transmitted in total reflection in the refractor 20b. The core 26 and the transmission layer 111 of the signal guide 11 may be integrally formed of one piece or be different members connected together. The cladding 27 and the first layer 112 of the signal guide 11 may be integrally formed of one piece or be different members connected together. The optical layer 28 may be provided of material the same as the upper layer 25 aforementioned (as shown in FIG. 2).

Although particular embodiments of the invention have been described in detail for purposes of illustration, various modifications and enhancements may be made without departing from the spirit and scope of the invention. Accordingly, the invention is not to be limited except as by the appended claims.

1. A transmission device for guiding a transmission signal, including:
a substrate including a signal guide configured to guide the transmission signal; and
a refractor arranged on the substrate and corresponding to the signal guide, the refractor provided with a progressive refractive index with which a divergence angle of the transmission signal progressively varies within the refractor;
wherein the signal guide includes a transmission layer and a first layer on the transmission layer, a part of the refractor extends through the first layer and contacts the transmission layer, and the part of the refractor and the first layer are integrally formed of one piece.

2. The transmission device of claim 1, wherein the refractor further includes a first end and a second end which is connected to the signal guide, and the progressive refractive index progressively increases or progressively decreases from the first end to the second end.

3. The transmission device of claim 2, wherein the signal guide includes a reflective face corresponding and angled to an end face of the refractor facing toward the signal guide, the signal guide further includes a substance next to the transmission layer, the substance is inorganic or organic, a refractive index of the substance is smaller than a refractive index of the transmission layer, the reflective face is formed between the transmission layer and the substance, and the substance is in gaseous, liquid, or solid state.

4. (canceled)

5. The transmission device of claim 1, wherein the refractor includes a plurality of layers of different refractive indices.

6. The transmission device of claim 1, further including an optical component, wherein the optical component is arranged on the substrate and corresponds to the refractor.

7. The transmission device of claim 6, further including a covering component covering the optical component, wherein the covering component is provided with electromagnetic wave shielding and a thermal conductivity greater than 3 W/mK.

8. The transmission device of claim 1, wherein the substrate further includes at least one electric conductive layer, at least one through hole which is disposed at least through the at least one electric conductive layer, and at least one conductive component arranged along the at least one through hole and connected with the at least one electric conductive layer, and the at least one conductive component includes at least one of a thermal conductive component and an electric conduct via.

9. The transmission device of claim 8, wherein the at least one conductive component includes at least one of inorganic and organic solid substances.

10. The transmission device of claim 1, further including a transmitting (Tx) end, a receiving (Rx) end, a driver IC and a transimpedance amplifier (TIA), wherein the substrate further includes at least one electric conductive layer, an optical transmitter connected with the driver IC is arranged at the transmitting end and corresponds to the refractor, an optical receiver connected with the transimpedance amplifier is arranged at the receiving end and corresponds to another said refractor, and the optical transmitter, the optical receiver, the driver IC and the transimpedance amplifier are connected with the at least one electric conductive layer.

11. The transmission device of claim 1, wherein each of the signal guide and the refractor contains at least one organic or inorganic transmittance material with a refractive index from 1.3 to 1.6.

12. The transmission device of claim 1, wherein the refractor includes a core corresponding to the signal guide, a cladding disposed around the core and an optical layer disposed on the core.

13. The transmission device of claim 1, further including an optical component, wherein the optical component is arranged on the substrate and corresponds to the refractor, and the refractor and a light passing surface of the optical component are in surface contact.
